(19) United States
(12) Patent Application Publication
(10) Pub. No.: US 2011/0087140 A1
(43) Pub. Date: Apr. 14, 2011

(54) MASSAGE DEVICE

(76) Inventor: Tee-Ing Lee, Taipei County (TW)

(21) Appl. No.: 12/888,123

(22) Filed: Sep. 22, 2010

(30) Foreign Application Priority Data
Oct. 13, 2009 (TW) 098218863

(51) Int. Cl. A61H 7/00

(52) U.S. Cl. 601/137

(57) ABSTRACT

A massage device includes a pair of bars, each having plural adjustment holes and plural positioning grooves located on the opposite side of the adjustment holes. A pair of massage balls are connected via connectors to arbitrary adjustment holes of the bars. A strap has each of its two free ends inserted into an end hole at a head end of one bar and extending out of a lateral hole adjacent to the end hole. Each free end of the strap that extends out of the lateral hole of one bar is connected with a hook. Each hook is hooked to the desired positioning groove of one bar to adjust the distance between the bars. The positions of the massage balls on the bars are also adjustable. Thus, the massage device is suitable for massaging different parts of the human body in a do-it-yourself manner and features effortlessness and effectiveness.

### BACKGROUND OF THE INVENTION

1. Technical Field

The present invention relates to a massage device and, more particularly, to a massage device including two bars which are provided with position-adjustable massage balls and are linked by a strap for adjusting the distance between the two bars, such that the massage device is suitable for massaging all parts of the human body manually in a do-it-yourself manner.

2. Description of Related Art

People who feel slightly under the weather usually resort to over-the-counter medicine or simply ignore the symptoms. When dealing with body soreness, westerners tend to use painkillers, and Asians, ointments or plasters. Besides, Asians appreciate the practice of massage therapy, which treats not only soreness of superficial muscles but also, in some cases, diseases of the human body.

As people can massage themselves, self-massaging tools are common in Asian people's daily lives, ranging from complicated electric massage machines to simple manual massage devices. Electric massage machines advantageously provide a sufficient massage force and easy operation but are nevertheless disadvantaged by their high power consumption and high selling prices. Manual massage devices, though requiring no electricity and sold at lower prices than electric massage machines, may produce inconsistent massaging effects that vary with the force exerted, and fatigue the operators when used for an extended period of time. One common drawback of the electric massage tools and the manual massage tools is that each tool is designed for massaging only some but not all parts of the human body. In particular, a user operating a manual massage tool on himself/herself may be restricted by his/her own body posture and hence have problem massaging certain body parts (e.g., the back) correctly and effectively.

While some useful manual massage tools have been proposed as in Taiwan Patent Nos. 235475 and 386435, these patented massage tools, like their predecessors, only produce satisfactory massaging effects on certain parts of the human body, particularly the parts with relatively small widths (e.g., the neck, shoulders, and legs). As to those relatively wide body parts (e.g., the upper back and lower back), the prior art devices leave much to be desired. Therefore, the inventor of the present invention boldly assumes that a manual massage tool capable of effectively massaging all parts of the human body has yet to be developed.

### BRIEF SUMMARY OF THE INVENTION

In view of the aforesaid drawbacks of existing massage tools, especially manual massage tools, it is an object of the present invention to provide a massage device designed specifically to solve the problem of the conventional manual massage tools that they are applicable only to particular body parts.

To achieve the above and other objects, the present invention provides a massage device which includes: a pair of bars, a strap, a pair of hooks, and a pair of massage balls. Each bar has: a plurality of adjustment holes, a plurality of positioning grooves provided on the opposite side of the adjustment holes, a head end formed with an end hole, and a surface which is provided with the positioning grooves and further formed with a lateral hole adjacent to the end hole, wherein the lateral hole communicates with the end hole. The strap has two free ends, each inserted into the end hole and then extending out of the lateral hole of one of the two bars. The two hooks are connected respectively to the free ends of the strap that extend out of the lateral holes of the bars. Each hook is hooked to an arbitrary one of the positioning grooves of one of the bars. The two massage balls are connected, by means of connectors, to arbitrary ones of the adjustment holes of the bars.

The distance between the two bars can be adjusted by fastening the hooks to the desired positioning grooves of the two bars respectively. Meanwhile, the positions of the massage, balls on the bars are also adjustable so as to include different massage positions. Therefore, the massage device of the present invention is applicable to all parts of the human body and hence advantageous over the existing manual massage tools. The feature of general applicability, coupled with the inherently high mechanical advantage of the long moment arms of the bars, allows a user to control the massage force according to the soreness to be dealt with and massage himself/herself easily and effectively.

The massage device described above further includes an extension bar to be connected to the tail end of each bar, so as to adapt the massage device to massage points which are spaced apart by a long distance or which are otherwise difficult to reach. Thus, the extension bars contribute to convenience and gracefulness of the massage operation.

The massage device described above further includes a reinforcing layer provided on the surface of each bar where the positioning grooves are formed. The reinforcing layers serve to increase the structural strength of the positioning grooves.

The pair of massage balls of the foregoing massage device can both be spherical and have smooth surfaces. Alternatively, the surface of one or both of the massage balls may have at least one protuberance.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is an assembled perspective view of a massage device according to a preferred embodiment of the present invention;

FIG. 2 is a partial sectional view of the massage device depicted in FIG. 1;

FIG. 3 is a detailed sectional view of positioning grooves formed on a bar of the massage device depicted in FIG. 1, showing particularly a reinforcing layer on a surface of the bar where the positioning grooves are formed;

FIGS. 4 to 6 show different application modes of the massage device according to the present invention, with FIG. 4 showing application to shoulders, FIG. 5 to the back, and FIG. 6 to other body parts;

FIG. 7 is an exploded perspective view showing the structure and an extension bar of the massage device according to the present invention;

FIG. 8 is a perspective view of another application mode of the massage device according to the present invention, wherein two bars and two extension bars are arranged in a side-by-side configuration; and

FIGS. 9A and 9B are perspective views showing another shape of the massage ball used in the massage device according to the present invention.

### DETAILED DESCRIPTION OF THE INVENTION

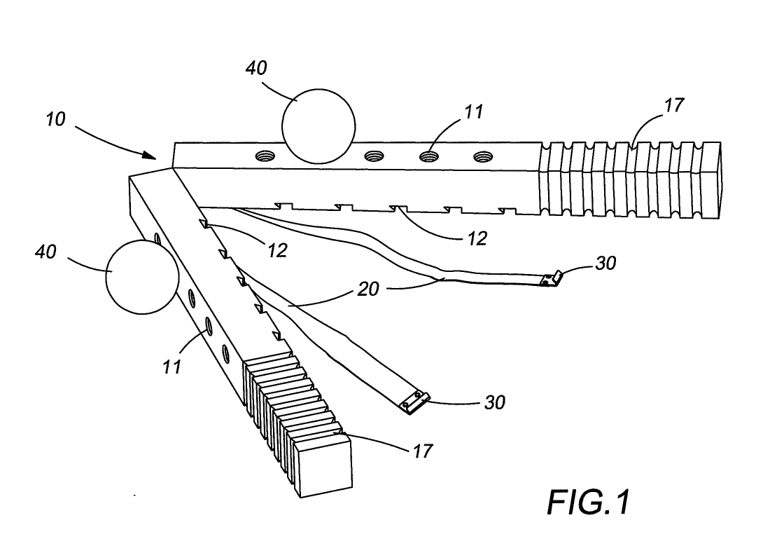

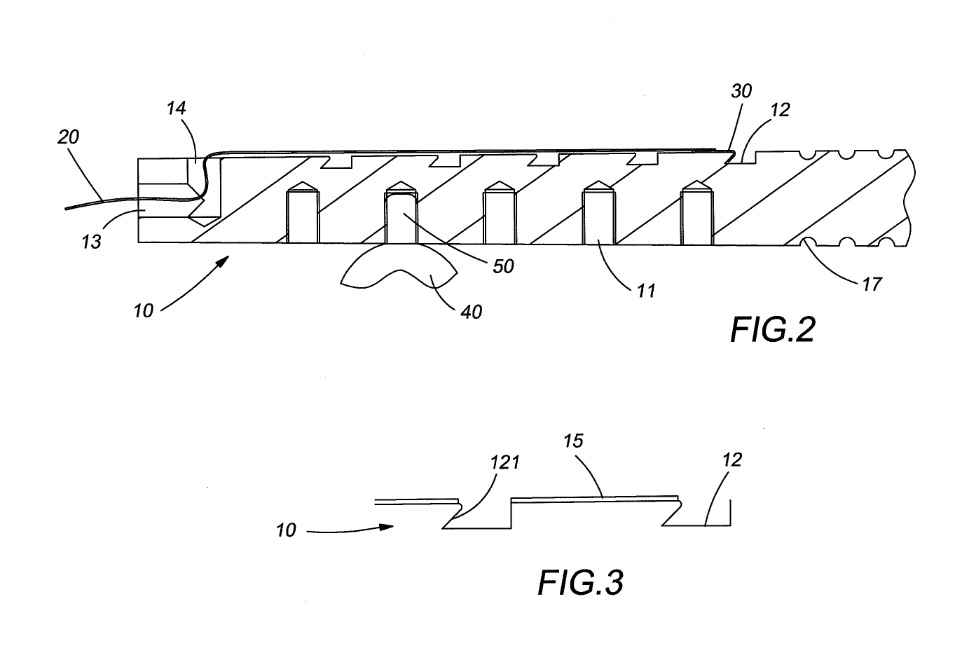

Referring to FIGS. 1 and 2, a massage device according to a preferred embodiment of the present invention includes a pair of bars 10, a strap 20, a pair of hooks 30, and a pair of massage balls 40. Each bar 10 has a plurality of adjustment holes 11 and a plurality of positioning grooves 12 provided on the opposite side of the adjustment holes 11. Besides, each bar 10 has a head end formed with an end hole 13. The surface of each bar 10 that is provided with the positioning grooves 12 is further formed with a lateral hole 14 adjacent to the end hole 13 of each said bar 10, wherein the lateral hole 14 communicates with the end hole 13. Each of the two free ends of the strap 20 is inserted into the end hole 13 and then extends out of the lateral hole 14 of one of the two bars 10. Each free end of the strap 20 that extends out of the lateral hole 14 of one bar 10 is connected with one of the hooks 30. Each hook 30 is hooked to an arbitrary positioning groove 12 of one of the bars 10. Each massage ball 40 is connected via a connector 50 to an arbitrary adjustment hole 11 of one of the bars 10.

In this preferred embodiment, the adjustment holes 11 of the bars 10 are threaded holes; therefore, the connectors 50 for connecting the massage balls 40 to the adjustment holes 11 are threaded fasteners such as bolts. However, the adjustment holes 11 may also be non-threaded holes, in which case the connectors 50 for connecting the massage balls 40 to the adjustments holes 11 are pins (not shown) that can fit tightly and securely into the adjustment holes 11. The connectors 50 can be stand-alone components connected between the massage balls 40 and the adjustment holes 11. The connectors 50 may also be formed as extensions of the massage balls 40 or as posts projecting from the surfaces of the bars 10. When formed as threaded fasteners, the connectors 50 may be fully or partially threaded, depending on the fastening effect desired.

In this preferred embodiment, each positioning groove 12 of the bars 10 has a wedge-shaped corner 121 as shown in FIG. 3, with a view to ensuring secure connection between the hooks 30 and the positioning grooves 12. Nonetheless, it is understood that the positioning grooves 12 may have other shapes capable of the same function. Furthermore, in order to prevent the strap 20, the hooks 30, and the positioning grooves 12 from damage by the pulling force generated during the massage process, the aforementioned components are made of materials resistant to such a pulling force or are provided with reinforcing means. Referring to FIG. 3 for another embodiment of the present invention for example, the surface of the bar 10 that is formed with the positioning grooves 12 is provided with a reinforcing layer 15 to reinforce of the surface around the positioning grooves 12.

The massage device according to the preferred embodiment of the present invention is used in the following manner. Before operation, the hooks 30 are hooked to the appropriate positioning grooves 12, and the massage balls 40 are connected by means of the connectors 50 to the desired adjustment holes 11 of the bars 10. The spacing between the two bars 10 is so adjusted that, by holding the two bars 10 near their respective tail ends and pressing the massage balls 40 against the body parts to be massaged (e.g., the neck, shoulders, back, abdomen, or legs), the strap 20 is brought into a slightly taut tensioned state. In the preferred embodiment of the present invention, as the positioning grooves 12 are provided on the opposite side of the adjustment holes 11, the strap 20 can readily enter the tensioned state during operation and is unlikely to get loose. However, the positioning grooves 12 may also be provided on any other surfaces of the bars 10 than those formed with the adjustment holes 11, provided that the strap 20 can be securely fastened to the bars 10 without falling off.

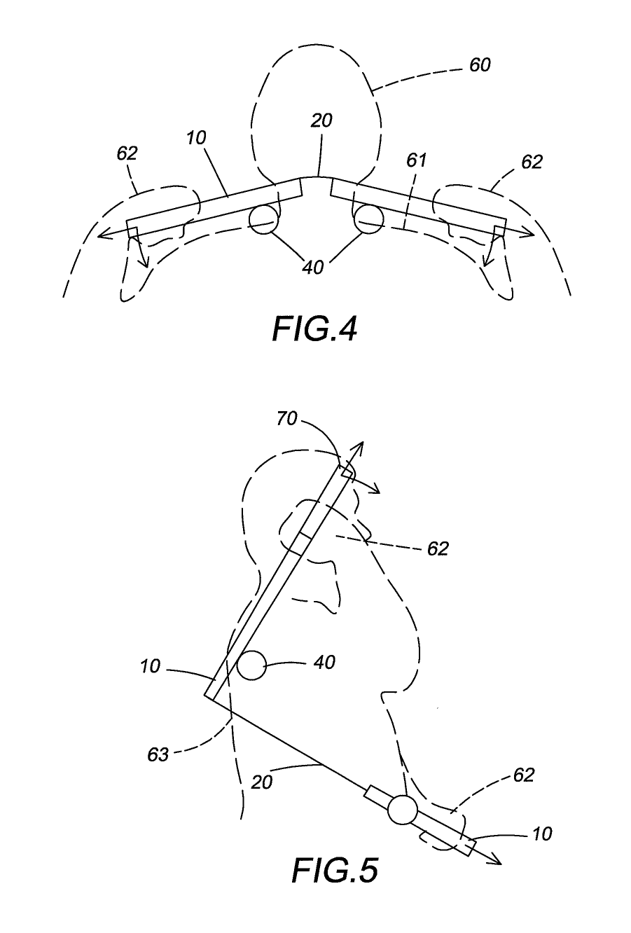

Please refer to FIG. 4, which shows the massage device according to the preferred embodiment of the present invention being applied to human shoulders. With proper adjustment of the spacing between the two bars 10, an operator 60 can use both hands 62 to hold the two bars 10 near their respective tail ends and press the two massage balls 40 against the top portions of the shoulders 61. Then, the two bars 10 can be pulled with both hands 62 toward the two lateral sides and pressed downward at the same time (as indicated by the arrows in FIG. 4), so that the massage balls 40 exert a downward pressure on the shoulders 61 and thereby produce a massaging effect.

Referring to FIG. 5, the massage device according to the preferred embodiment of the present invention is operated in a similar way to that shown in FIG. 4; however, the two bars 10 in FIG. 5 are wound around the operator 60's back 63, with the two hands 62, one up and one down, pulling outward. Then, using the lower bar 10 as a fulcrum, the upper bar 10 is pressed downward (as indicated by the arrows in FIG. 5) such that the upper massage ball 40 presses against the back 63 to produce a massaging effect.

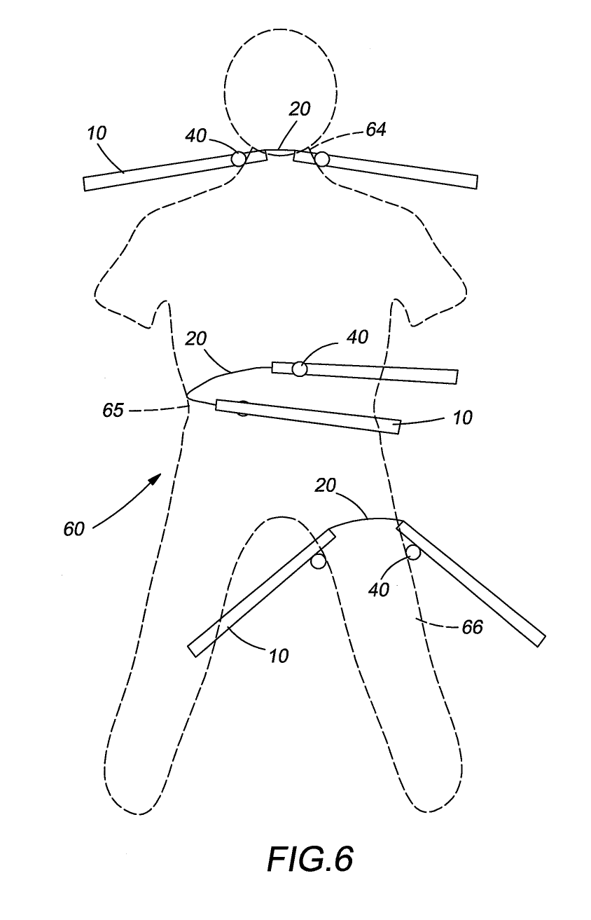

Aside from the massage positions shown in FIGS. 4 and 5, the massage device according to the preferred embodiment of the present invention is applicable to other parts of the human body. As illustrated in FIG. 6, the massage device can be used around the neck 64, the abdomen 65, the leg 66, or any other body part that needs massaging.

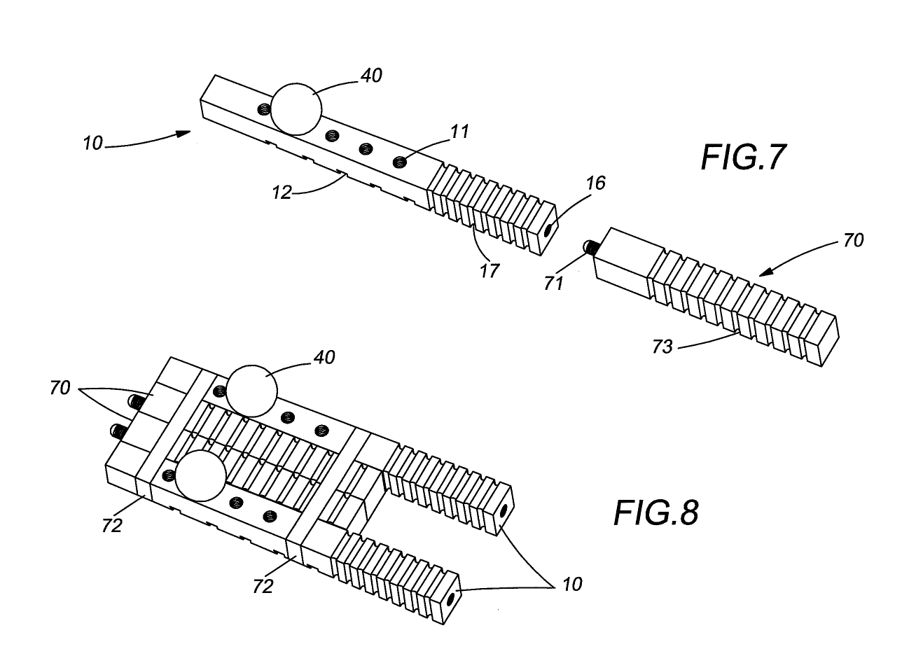

Referring to FIG. 7, the massage device according to the preferred embodiment of the present invention may further include at least one extension bar 70 to be connected to the tail end of each bar 10. The extension bar 70 has a head end provided with a pin or, as shown in FIG. 7, a bolt 71; in the latter case, the tail end of the bar 10 that is to be connected with the extension bar 70 is formed with a threaded hole 16. In a different embodiment, however, the pin or bolt 71 is provided at the tail end of the bar 10. The extension bar 70 is intended to extend the length of the bar 10 and thereby provide a convenient point of force application for massaging certain body parts. Taking the back massage depicted in FIG. 5 for example, one or both of the bars 10 can be extended with the extension bar 70 so as to provide longer moment arms, which not only have greater mechanical advantage but also increase operational convenience.

In addition to the configuration described above, wherein the two bars 10 are linked by the strap 20 so as to be held with both hands during the massage operation, the massage device according to the preferred embodiment of the present invention may also be used in a different configuration in which the bars 10 are connected with the extension bars 70 to form a variation of the massage device. Referring to FIG. 8, the two extension bars 70 are arranged in parallel between the two bars 10, with a clamping element or a fastening strap 72 holding all the bars firmly together. In use, the assembly of bars is placed on a flat surface in such a way that the bar surfaces mounted with the massage balls 40 face upward. Then, the user lies on the assembly of bars, with the body parts that need massaging resting on the massage balls 40. In this application mode, the number and positions of the massage balls 40, the number and arrangement of the bars 10 and the extension bars 70, and the position of the user's body with respect to the assembly of bars can all be adjusted to suit practical massage needs.

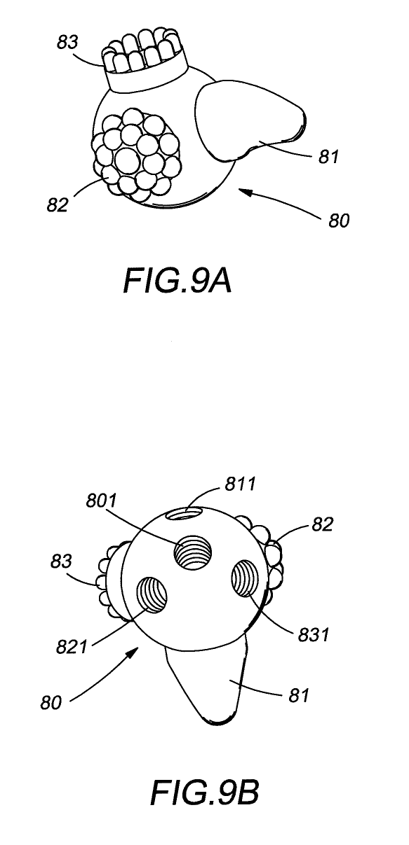

While the pair of massage balls 40 in the preferred embodiment of the present invention are shown as being spherical and having smooth surfaces, massage balls of other shapes are also contemplated. For instance, referring to FIGS. 9A and 9B, the massage ball 80 has at least one protuberance on its surface, wherein the at least one protuberance includes a horn-shaped protuberance 81, a ball-cluster protuberance 82, and a post-cluster protuberance 83. In addition, the massage ball 80 has a pin hole or threaded hole 811, 821, 831 located diametrically opposite each protuberance 81, 82, 83, as well as a pin hole or threaded hole 801 for fixing the massage ball 80 in position to the bar 10 via the connector 50. The connector 50 can be connected with each of the threaded holes 801, 811, 821, 831 that are located at different positions, so that any one of the protuberances 81, 82, 83 of the massage ball 80 can serve as the main massaging surface, thereby creating different forces and different sensations during the massage operation. When the connector 50 is connected with the central threaded hole 801 of the massage ball 80, the massage ball 80 can be rotated about the connector 50, thus allowing the user to choose the protuberance at a particular angle as the main massaging surface without having to remove the massage ball 80 and use a different threaded hole thereon.

Referring to FIG. 7, in the preferred embodiment of the present invention, a section of the bar 10 that is adjacent to the tail end is formed with annular grooves 17; similarly, a section of the extension bar 70 that is adjacent to the tail end is formed with annular grooves 73. The grooves 17, 73 are configured mainly to increase friction, thereby enabling a firm hold and providing an anti-slip function during the massage operation. However, it is understood that the same function can be achieved by other designs as well, such as by providing the bars 10 with a studded, embossed, or helical surface. Besides, while the bars 10 of the massage device in the preferred embodiment have rectangular cross-sections, it is feasible for the bars 10 to have other cross-sectional shapes. Furthermore, in the preferred embodiment of the present invention, each bar 10 tapers toward its head end in order to provide an optimal operation angle for massage. Nevertheless, the tapered design is not essential; the intended effects of the massage device of the present invention can be equally obtained if the bars 10 have uniform widths.

The embodiments described above serve only to demonstrate the preferred mode of carrying out the present invention but are not intended to limit the scope of the present intention. A person of ordinary skill in the art who has reviewed the technical contents disclosed herein may change or modify the foregoing embodiments without departing from spirit of the present invention. Therefore, the scope of the present invention is defined only by the appended claims.

What is claimed is:

1. A massage device, comprising:
a pair of bars, each said bar having: a plurality of adjustment holes; a plurality of positioning grooves provided on an opposite side of the adjustment holes; a head end formed with an end hole; and a surface provided with the positioning grooves and further formed with a lateral hole adjacent to and in communication with the end hole;
a strap having two free ends, each said free end inserted into the end hole and extending out of the lateral hole of one of the two bars;
a pair of hooks connected respectively to the free ends of the strap that extend out of the lateral holes of the bars, each said hook being hooked to a said positioning groove of one of the bars; and
a pair of massage balls, each said massage ball being connected via a connector to a said adjustment hole of one of the bars.

2. The massage device of claim 1, further comprising an extension bar connectable to a tail end of each said bar.

3. The massage device of claim 2, wherein the extension bar is connectable to the tail end of each said bar via a pin.

4. The massage device of claim 2, wherein the bars have anti-slip friction surfaces adjacent to the respective tail ends, and the extension bar has a tail end and an anti-slip friction surface adjacent thereto.

5. The massage device of claim 1, wherein the adjustment holes of the bars are threaded holes, and the connectors for connecting the massage balls to the bars are bolts.

6. The massage device of claim 1, wherein the adjustment holes of the bars are non-threaded holes, and the connectors for connecting the massage balls to the bars are pins.

7. The massage device of claim 1, further comprising a reinforcing layer provided on the surface of each said bar that is provided with the positioning grooves.

8. The massage device of claim 1, wherein both said massage balls are spherical and have smooth surfaces.

9. The massage device of claim 1, wherein at least one of the massage balls has a surface provided with at least a protuberance.

10. The massage device of claim 9, wherein each said massage ball that is provided with the at least a protuberance has a connecting hole located diametrically opposite each said protuberance.
